(19) United States
(12) Patent Application Publication
(10) Pub. No.: US 2012/0152829 A1
(43) Pub. Date: Jun. 21, 2012

(54) BIOLOGICAL WASTEWATER TREATMENT METHOD

(75) Inventors: Garry Mark Henderson, Indooroopilly (AU); Thomas Blair Connor, Brookfield (AU)

(73) Assignee: Kellogg Brown & Root LLC, Houston, TX (US)

(21) Appl. No.: 13/391,682

(22) PCT Filed: Jun. 21, 2010
(86) PCT No.: PCT/AU2010/000765

§ 371 Date: Feb. 22, 2012

(30) Foreign Application Priority Data
Aug. 24, 2009 (AU) 2009904014

(51) Int. Cl. C02F 3/32

(52) U.S. Cl. 210/604

(57) ABSTRACT

The invention relates to a method of treating wastewater, and includes capturing carbon dioxide and oxygen produced during treatment of the wastewater by a wastewater treatment system, and using the captured carbon dioxide and oxygen to promote the growth of algae contained within the wastewater treatment system.

### CROSS REFERENCE TO RELATED APPLICATIONS

This application claims the benefit of Australian Provisional Patent Application having Serial No. 2009904014, filed on Aug. 24, 2009 and International Application No. PCT/AU2010/000,765, filed on Jun. 21, 2010. Both applications are incorporated by reference herein.

### BACKGROUND

### Field

The present invention relates to methods for treating wastewater. More particularly, this invention relates to wastewater treatment methods utilizing an algal bioreactor.

Wastewater treatment requirements continue to heighten in response to health and environmental concerns regarding the impact of released effluents. Increasingly, many industrialized countries throughout the world are imposing more stringent effluent discharge regulations and standards.

Compliance with these stringent effluent discharge requirements will require modifications and/or equipment additions to existing treatment facilities, or incorporation of such modifications or equipment additions into the design of new treatment facilities.

An additional desirable outcome of wastewater treatment is the cultivation of a desired biomass, with concomitant sequestration of carbon dioxide, during the treatment process.

It is an object of the invention to provide improved methods of wastewater treatment, including improved cultivation of a desired biomass, in response to the aforementioned heightened wastewater treatment requirements.

### SUMMARY OF THE INVENTION

The present invention is directed to methods for treating wastewater.

In one form, although not necessarily the broadest or only form, the invention resides in a method of treating wastewater, the method including the steps of capturing carbon dioxide and oxygen produced during treatment of the wastewater by a wastewater treatment system; and using the captured carbon dioxide and oxygen to promote the growth of algae contained within the wastewater treatment system.

The process of the treatment does not depend on a particular type of wastewater. Rather, any water source having one or more constituents capable of being decomposed, converted or metabolized by biological means may be treated according to the methods disclosed herein. Thus, any polluted water, whether polluted as a result of natural or human impact, and from any source may be treated according to the methods disclosed herein. Alternatively, the wastewater may be a manufactured or engineered media designed to support the growth of a biological organism to generate biomass, such as, for example, a media designed to support the growth of algae. In typical operation, the wastewater will be from a community, industrial or residential source. For example, the wastewater may be delivered from a municipal, farming or other large-scale sewage system. Alternatively, the wastewater may be generated, for example, by food processing or pulp and paper plants. Furthermore, the wastewater may be sourced from a polluted body of water, such as a pond (including a holding pond), a lake, a river, and the like. The wastewater may be moved through the wastewater treatment system by operation upstream or downstream of the system.

Typically, the wastewater will bear at least one constituent capable of being decomposed, converted or metabolized by biological means. The constituent may be a biodegradable material, such as an inorganic or organic compound that participates in or is involved in decomposition, conversion or metabolism by biological means. For example, the constituent may include biodegradable material such as nitrate, nitrite, phosphorous, ammonia, and the like, typically present in wastewater. The type and concentration of such constituents present in the wastewater may be site-specific. Communities may establish regulations regarding these constituents. For the purposes of the present description, wastewater refers to what is fed to a wastewater treatment system and what is treated throughout the system.

An exemplary wastewater treatment system will have a population of biological organisms, including one or more types of algae and/or bacteria, used to digest, decompose, convert, or metabolize constituents found in the wastewater. The biological organisms may be housed in one or more bioreactors or digesters, including any type of container, vessel or device (including a closed container, vessel or device) used for modifying and/or generating products using the natural or engineered conversion capacity of the biological organism (e.g., algae and bacteria), such as enzyme reactions and fermentation, and includes fermenters.

The decomposition, conversion or metabolism of constituents, such as pollutants and biodegradable material, to innocuous compounds, or compounds or products with value, is facilitated or mediated by the biological organisms as the wastewater is passed through the wastewater treatment system. A recycle system may be employed in the wastewater treatment system to allow wastewater to pass through the system more than one time, including multiple times. A mass of biological organisms typically requires one or more environments that provide the proper conditions for growth and/or biological activity.

A bioreactor may have one or more treatment zones that provide the proper conditions for growth and/or biological activity of the biological organisms. Such treatment zones can be characterized as promoting, effecting or exhibiting a type of metabolic activity or biological process. For example, biological organisms that rely in whole or in part on exposure to sunlight, such as algae, can be grown in a treatment zone of a bioreactor operated in an outdoor environment, where it is exposed to environmental light.

Multiple treatment zones or regions may be housed in a single bioreactor. Alternatively, a treatment zone or region may be housed in a separate bioreactor, wherein a different treatment is carried out in each separate bioreactor. The bioreactors and treatment zones may be sized and shaped according to a desired application and to accommodate a volume of wastewater to be treated. For example, hydraulic residence times of various unit operations of the treatment system may depend on factors such as influent flow rate, effluent requirements, concentration of target compounds in the influent stream, temperature, and expected peak variations of any of these factors.

Each treatment zone may contain media, such as solid media, liquid media or fluidisable media, to host the biological organisms. Each treatment zone may be maintained at different conditions to enhance growth of different biological organisms, which may promote different biological processes. For example, passing wastewater through denitrifying bacteria may increase the efficiency of a denitrifying process. Likewise, passing wastewater through nitrifying bacteria may increase the efficiency of a nitrifying process. The bioreactor may also include means for maintaining the media within each treatment zone during operation. For example, a screen, perforated plate, baffle, or fluid countercurrents may be used to maintain the media within each treatment zone. The media may, but need not be, similar in each treatment zone.

Exemplary treatment zones include a photosynthesis zone, an aerobic zone, an anaerobic zone, and an anoxic zone. A photosynthesis treatment zone may be used to culture biological organisms that rely in whole or in part on exposure to sunlight, for example, photosynthetic organisms, such as algae. A bioreactor having a photosynthesis treatment zone may also contain a system for temperature control, such as a thermal barrier. For example, the photosynthesis treatment zone may be formed using flexible plastic, such as plastic bags or tubes, with an internal adjustable thermal barrier layer within the bags or tubes. The bags, tubes and thermal barrier may be constructed of a variety of materials, such as, for example, polyethylene, polypropylene, polyurethane, polycarbonate, polyvinylpyrrolidone, polyvinylchloride, polystyrene, poly(ethylene terephthalate), poly(ethylene naphthalate), poly(1,4-cyclohexane dimethylene terephthalate), polyolefin, polybutylene, polyacrylate, and polyvinylidene chloride. When culturing algae, the material of the bags, tubes and thermal barrier preferably exhibits a transmission of visible (photosynthetic) light of at least 50%, such as at least 60%, 75%, 90%, 95%, and 100%.

One or more layers of ultraviolet (UV) blocking material may be applied to the surface of the bags or tubes to reduce UV-degradation of the plastic. Fluorescent dyes that convert infrared (IR) or UV light to the visible light spectrum may be incorporated into the bags or tubes to increase efficiency of solar energy capture by photosynthetic organisms.

In bioreactors employing a photosynthesis treatment zone with a thermal barrier, media (e.g., liquid or fluidisable media) may be directed either above or below the thermal barrier. Under conditions of low temperature, the media may be directed above the thermal barrier, where it is exposed to increased solar irradiation, including infrared wavelengths, resulting in a temperature increase. Under high temperature conditions, the media may be directed below the thermal barrier, where it is partially shielded from solar irradiation and simultaneously may lose heat by contact with an underlying layer, such as a ground layer. The layer underlying the photosynthesis treatment zone may be used as a heat sink and/or heat source, storing heat (e.g., during the day) and releasing heat (e.g., at night).

An aerobic treatment zone is maintained at aerobic conditions to promote the growth and/or metabolic activity of aerobic bacteria (sometimes termed aerobic digestion). Under aerobic conditions, oxygen is the terminal electron acceptor for biological processes. Aerobic bacteria may, for example, facilitate and/or enhance the efficiency of a nitrifying bioprocess in which ammonia is oxidized to form nitrite which is in turn converted to nitrate. Aerobic bacteria may also, for example, facilitate and/or enhance the efficiency of a phosphorous uptake bioprocess in which soluble phosphorous is restored to the bacteria.

An anaerobic treatment zone is maintained at anaerobic conditions to promote the growth and/or metabolic activity of anaerobic bacteria (sometimes termed anaerobic digestion). Anaerobic conditions refer, in general, to an absence of oxygen, although the absence need not be absolute. For example, an anaerobic treatment zone may be maintained at less than 0.2 mg/L of dissolved oxygen (DO) content, such as, for example, less than 0.1 mg/L of DO content or less than 0.05 mg/L of DO content. Under anaerobic conditions, endogenous organic compounds, such as carbohydrates, serve as the terminal electron acceptor for biological processes, in a fermentation process. Anaerobic bacteria may, for example, facilitate and/or enhance the efficiency of a phosphorous release bioprocess in which the bacteria may take up volatile fatty acids through a mechanism involving hydrolysis and release of phosphate.

An anoxic treatment zone is maintained at anoxic conditions to promote the growth and/or metabolic activity of anoxic bacteria (sometimes termed anoxic digestion). Anoxic conditions refer, in general, to a lack of oxygen (similar to anaerobic conditions), although similarly, the absence need not be absolute. For example, an anoxic treatment zone may be maintained at less than 0.5 mg/L of DO content, such as, for example, less than 0.2 mg/L of DO content or less than 0.1 mg/L of DO content. Under anoxic conditions, NOₓ (e.g., NO₂ and NO₃) serves as the terminal electron acceptor for biological processes, with the concomitant production of nitrogen gas.

A bioreactor may include additional treatment zones not herein described. One or more bioreactors and/or one or more treatment zones therein may be run simultaneously. One or more bioreactors and/or one or more treatment zones therein may be operated continuously or as a batch process.

The wastewater treatment system may also contain one or more filters or separators. A filter or separator may include one or more unit operations capable of separating a wastewater stream into one or more components. For example, it may filter and/or clarify the wastewater stream to produce a concentrated liquid stream and a filtrate, such as a semi-solid or solid. The filter or separator may be positioned upstream or downstream of one or more of the biological treatment zones to act upon the wastewater stream before or after, respectively, it has undergone biological processes and/or while it is undergoing biological processes. The filter or separator may be housed in the bioreactor with the one or more treatment zones. Alternatively, the filter or separator may be housed in a separate vessel apart from the bioreactor.

In some embodiments, the filter or separator may include a membrane operating system (MOS). The MOS may have one or more porous or semi-permeable membranes, positioned so as to be submerged, or submergible, during operation and may have any configuration suitable for a particular purpose, such as a sheet or hollow fibre or tube. The membrane may be formed of any material (natural or synthetic) suitable for a particular filtration process.

Representative organic polymers suitable for use in forming porous or semi-permeable membranes include: polysulfone; polyethersulfone; polycarbonate; cellulosic polymers, such as regenerated cellulose polymer, cellulose diacetate polymer, cellulose triacetate polymer, cellulose nitrate polymer, and blends thereof; polyamide; polyimide; polyetherimide; polyurethane; polyester; polyacrylate and polyalkyl methacrylate, such as polymethyl methacrylate; polyolefins, such as polyethylene and polypropylene; saturated and unsaturated polyvinyls, such as polyvinyl chloride, polyvinyl fluoride, polyvinylidene chloride, and polyvinylidene fluoride; polyvinyl alcohol; fluorine substituted polymers, such as polytetrafluoroethylene and poly(tetrafluoroethylene-perfluoropropylvinylether); polyetheretherketone; polyacrylonitrile; and polyphosphazine. Representative inorganic substrate compositions include, for example, zirconia, alumina, titanium dioxide, BaTiO₃ based microporous media, and the like.

Materials selected for membranes will generally have attributes that render them suitable for filtration service, such as structural integrity, to withstand the pressure gradients of filtration, oxygenation and backflushing, and chemical resistance to attack or dissolution by the filtered species, filtrate and chemical cleaning solutions such as chlorine, citric acid, sodium hydroxide, and other chemicals designed to minimize organic and inorganic fouling of membranes. Design criteria and considerations in the fabrication of microfiltration and ultrafiltration devices are disclosed, for example, in Zeman, et al., Microfiltration and Ultrafiltration Principles and Applications, Marcel Dekker, Inc., New York, N.Y., 1996.

One or more membranes may be positioned in one or more membrane modules within the MOS. The membrane modules may have any shape and cross-sectional area suitable for use in a desired application, for example, square, rectangular or cylindrical. Multiple membrane modules may be positioned adjacent to one another or at predetermined positions within the MOS. The membrane modules may be positioned at any angle, including vertical and horizontal, within the MOS. In one embodiment, a plurality of membrane modules may be mounted to a module support rack to facilitate membrane maintenance and/or replacement.

One or more porous or semi-permeable membranes may also be combined with a bioreactor to provide a membrane biological reactor (MBR), which combines biological treatment, as described herein, with a membrane separation step, as described herein. In particular, a MBR uses membranes, rather than settling, to separate and concentrate solid material by removing liquid, in some cases eliminating the need for secondary clarification and/or filtration.

Depending on the contents of the wastewater, the given system requirements and quality requirements of the effluent, the membranes utilized in a MBR can be of any type or porosity, positioned so as to be submerged, or submergible, during operation and may have any configuration suitable for a particular purpose, such as a sheet or hollow fibre or tube. Generally, MBRs may include reverse osmosis, nanofiltration, ultrafiltration, microfiltration, and any other solid/liquid separation membranes known to those skilled in the art. Thus, in addition to removing biodegradable organics, suspended solids and inorganic nutrients, MBRs retain particulate matter, remove a high percentage of pathogens and/or remove dissolved materials from the wastewater.

Liquid circuits may operate within the wastewater treatment system, and include various connections and arrangements of valves and lines that allow a liquid stream to flow therein. A liquid circuit may fluidly connect one or more components of the wastewater treatment system, such as processing and storage vessels, fermenters and bioreactors. As will be well known to one of skill in the art, liquids, including wastewater, in a fluid circuit may be moved by means of gravity, pumps, compression rollers, and the like.

The wastewater treatment system may also contain means for agitating or mixing the contents of the various components of the system, including the contents of one or more bioreactors, such as rotational mixers and axial vortexers. Agitating or mixing the contents of the various components of the system can also be achieved through aeration, that is, the introduction of a gas (e.g., bubbling) into a liquid environment within the system. Agitation and mixing provide for improved distribution of nutrients within the system, as well as improved decomposition, conversion or metabolism of constituents in the wastewater by the biological organisms of the system.

The wastewater treatment system may further contain devices for the extraction, capture, or collection, separation, and storage of gases from the various components of the system, including the one or more bioreactors of the system. Gases of interest include, for example, oxygen (O₂), carbon dioxide (CO₂), and methane (CH₄). Suitable devices for the extraction, capture, or collection of gases include, for example, vacuum pumps and the like. Following capture, gases may be compressed (including liquefaction) to facilitate separation, storage and/or transportation. Captured gases (whether compressed or not) may be separated, including into mixtures and individual gases, as desired. Methods for the separation of a mixture of gases into one or more submixtures or individual gases are well known in the art, and include, for example, membrane separation (e.g., using porous and nonporous membranes), adsorption, absorption, and cryogenic distillation.

Gas circuits may operate within the wastewater treatment system, and include various connections and arrangements of valves and lines that allow a gas stream to flow therein. A gas circuit may gaseously connect one or more components of the wastewater treatment system, such as fermenters and bioreactors, as well as capture, separation, compression, and storage vessels. A gas circuit may pass through, or include inline, one or more filters, such as one or more membrane filters, to remove particulate matter from the gas(es).

The wastewater treatment system may also include a source of CO₂, to facilitate low nutrient effluent water and to maximize the production of biomass in the wastewater treatment system, for example, in the one or more bioreactors of the system. A source of CO₂ may include, for example, combustion sources, such as exhaust gases generated by power plants, factories and/or other fixed source generators of CO₂. A combustion source of CO₂ may also supply nitrogen, in the form of NOₓ, for use in the wastewater treatment system. An optional or further source of CO₂ includes non-combustible sources, such as, for example, recycled CO₂ from anaerobic digestion within components of the wastewater treatment system, for example, the one or more bioreactors of the system and/or one or more anaerobic digesters. Anaerobic digestion within components of the wastewater treatment system may require the addition of water, for example, wastewater, to facilitate the digestion.

The CO₂ may be introduced into the one or more bioreactors of the system, for example, by bubbling through the wastewater stream and/or the liquid or fluidisable media. For example, CO₂ may be introduced by bubbling the gas through a perforated membrane, which produces small bubbles with a high surface to volume ratio for maximum exchange. The perforated membrane may be located at the bottom of a liquid column in which the wastewater flows in the opposite direction to bubble movement. This counterflow arrangement maximizes gas exchange by increasing the time the bubbles are exposed to the aqueous environment. To further increase CO₂ dissolution, the height of the liquid column may be increased to lengthen the time that bubbles are exposed to the aqueous environment. Dissolved CO₂ may be “fixed” by photosynthetic aquatic organisms, such as algae, to produce organic compounds.

Collection systems, such as sippers, may be arranged to siphon concentrated suspensions of biological organisms, including biomass, out of the wastewater treatment system. The hydrodynamic flow through the one or more bioreactors can be designed to produce a “whirlpool” effect, for example in a chamber at one end of the bioreactors. The whirlpool may be used to concentrate biological organisms, such as algae, within the media, allowing more efficient harvesting, or to remove undesired by-products of metabolism.

Solids, including solids produced within the wastewater treatment system (e.g., biomass produced through the decomposition, conversion or metabolism of constituents in the wastewater by the biological organisms, such as algae), may be separated from the treated wastewater using a variety of means, including, for example, filters, centrifuges and belt-presses. The residual water may then be held in a holding vessel for re-use, discharged (e.g., to a receiving stream or to the environment) or further processed (in the same or a different wastewater treatment system).

The wastewater treatment system may be used to produce a desired biomass, such as an animal or human food source, for example, by culturing edible algae, such as a Spirulina spp. The cultures of algae may also be used to support growth of a secondary food source, such as shrimp or other aquatic species that feed on algae. Methods of shrimp farming and aquaculture of other edible species are well known in the art. Alternatively, the biomass may be further processed to produce fertilizer, biofuel and/or other products of value.

Lipid or oil-producing algae include a wide variety of algae, such as the diatoms (bacillariophytes), green algae (chlorophytes), blue-green algae (cyanophytes), and golden-brown algae (chrysophytes). Exemplary bacillariophytes capable of oil production include the genera Amphipleura, Amphora, Chaetoceros, Cyclotella, Cymbella, Fragilaria, Hantzschia, Navicula, Nitzschia, Phaeodactylum, and Thalassiosira. Exemplary chlorophytes capable of oil production include the genera Ankistrodesmus, Botryococcus, Chlorella, Chlorococcum, Dunaliella, Monoraphidium, Oocystis, Scenedesmus, and Tetraselmis. Exemplary cyanophytes capable of oil production include the genera Oscillatoria and Synechococcus. An example of a chrysophyte capable of oil production is the genera Boekelovia. A combination of two or more strains of algae can be used in the wastewater treatment system.

### BRIEF DESCRIPTION OF THE DRAWING

An embodiment will now be described, by way of example only, with reference to the accompanying FIGURE in which:

FIG. 1A-1C is a flow diagram of a process for treating wastewater, including the capture and reuse of gases generated by a wastewater treatment system.

### DETAILED DESCRIPTION OF THE INVENTION

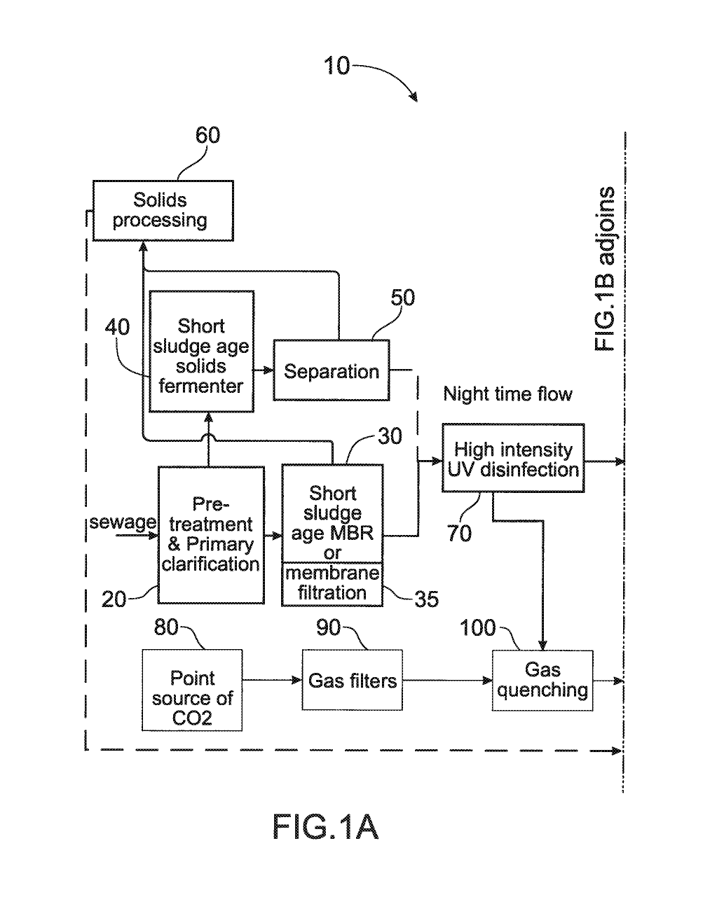

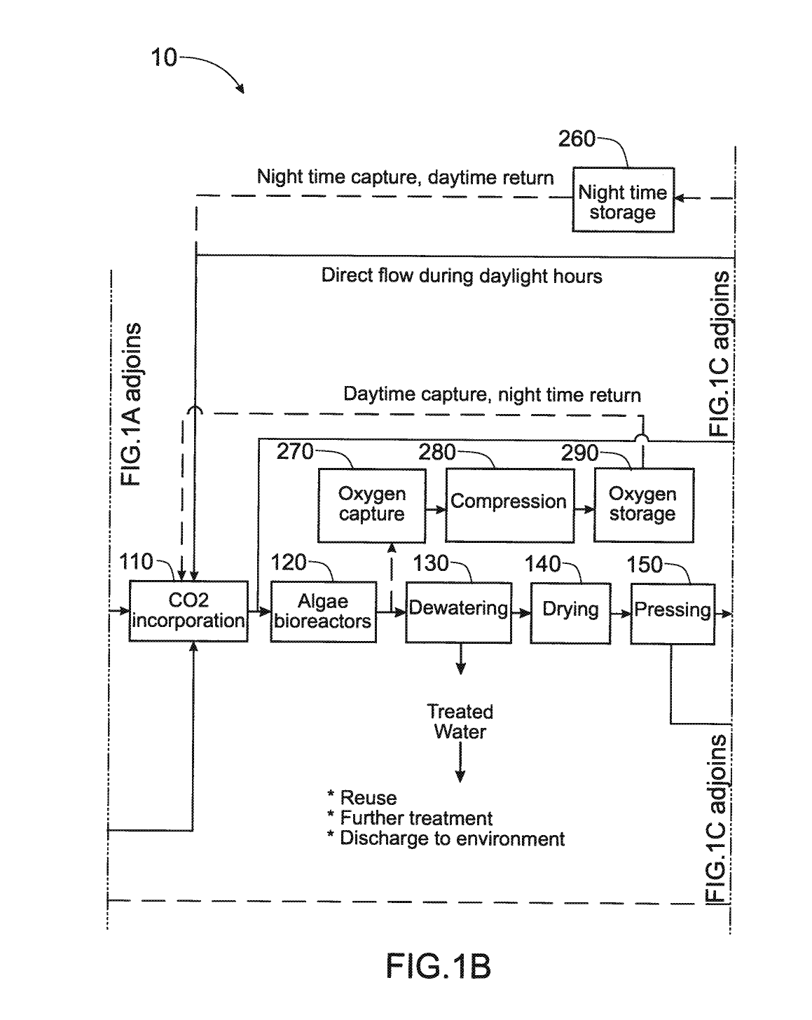

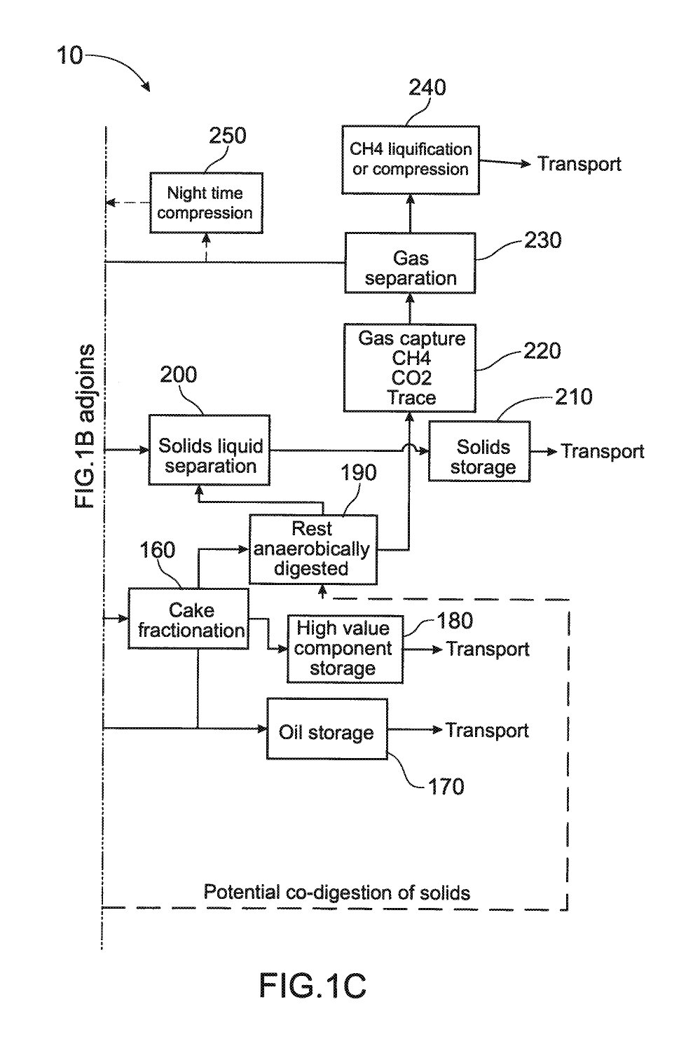

Referring now to FIG. 1A-1C, wastewater is treated in a wastewater treatment system 10. Raw sewage enters a primary clarifier 20 for separation of the majority of the solids from the liquid in the wastewater treatment system 10.

A short sludge age membrane biological reactor (MBR) 30 provides additional solid/liquid separation. It will be appreciated that a membrane filter 35 can be used in place of the MBR 30.

Solids produced by the primary clarifier 20 are processed in a short sludge age fermenter 40, with solids from the primary clarifier 20 periodically pumped into the short sludge age fermenter 40. The short sludge age fermenter 40 is mixed periodically. The purpose of the short sludge age fermenter 40 is to use anaerobic bacteria to convert complex organic matter in the wastewater to organic acids (i.e., fatty acids), which are more readily digested by biological organisms, including algae. It will be appreciated that use of the short sludge age fermenter 40 is an optional step.

The liquid phase of the fermented sludge from the short sludge age fermenter 40 is separated from the solids in a separator 50. Separator 50 is a Z-filter, a standard belt-press, a centrifuge, or other similar device. The liquid stream can then be further filtered, using the same membrane filter 35 as the main wastewater flow if biological treatment is not provided by MBR 30, or a separate filtration unit if MBR 30 is used.

A system of solids processing 60 includes stabilizing and disinfecting the solids. This is done by thermophilic (˜55° C.) anaerobic digestion, followed by mesophilic (˜35° C.) digestion. This can include using the same anaerobic digester 190 used to digest the residual biomass from algae production in the algal bioreactor 120. The products will be residual biomass (e.g., anaerobic bacteria & non-biodegradable organic compounds), water, methane, carbon dioxide, ammonia and other trace gases.

High intensity UV disinfection 70 is used to protect the algae in the algal bioreactor 120 from contamination by micro-organisms from the sewage. In particular, high intensity UV is particularly effective at inactivating viruses.

A point source of carbon dioxide 80 is required to achieve low nutrient effluent water and to maximize the biomass produced in the algal bioreactor 120. The point source of carbon dioxide 80 can be any source of carbon dioxide, such as a combustion source (which could also supply nitrogen in the form of NO gases if nitrogen is limiting). The point source of carbon dioxide 80 can be a non-combustion source, including the recycled carbon dioxide from the anaerobic digester 190, dependent upon the overall mass balance.

If the point source of carbon dioxide 80 is a solids combusting process, the exhaust gases will pass through a gas filter 90, to remove particulate matter in the gases. Additionally, cooling the gases will reduce the size of the gas injection piping and equipment, and will also improve the efficiency of dissolution of the carbon dioxide. Cooling is achieved by a quenching process 100. It will be understood that other gas cooling technologies can be used to cool the exhaust gases.

A carbon dioxide incorporation process 110 is the means of dissolving the carbon dioxide into the wastewater for the algae in the algal bioreactor 120 to be able to utilize it. One method of doing this is to use venturi sections and piped carbon dioxide. Additional technologies, including diffusers can also be used to incorporate carbon dioxide into the wastewater.

Wastewater enters the algal bioreactor 120, which can be any type of bioreactor, including open race-track style bioreactors, closed bioreactors of any type or any other bioreactor configuration. The algal bioreactor 120 provides an appropriate environment for the growth of algae.

Dewatering of the algae grown in the algal bioreactor 120 is achieved by a dewatering system 130. Dewatering system 130 is a Z-filter, a standard belt-press, a centrifuge, or other similar device for separating the algal biomass and the wastewater. The wastewater separated from the algal biomass in the dewatering system 130 is a treated water that is equivalent to a secondary treated wastewater. Depending on its origins, the treated water is typically suitable for release to the environment without further treatment, such as for irrigation. If the treated water is to be reused for a higher use, it may require further treatment, such as further disinfection or advanced water treatment to reduce salts and/or recalcitrant organic compounds.

Drying of the algal biomass is achieved by a drying system 140. The drying system 140 is an enclosed and forced air solar drier. Additional drying technologies can be used to provide a dry biomass cake from the algal biomass.

The dried algal biomass cake is subjected to a pressing process 150 to extract oil from the cake.

The dried algal biomass cake is also, or alternatively, subjected to a cake fractionation process 160. The cake fractionation process 160 extracts different components from the dried algal biomass cake. The cake fractionation process 160 includes supercritical carbon dioxide extraction, solvent extraction or any other method of separating components of the algal biomass.

An oil storage system 170 is used to store the oil extracted during the pressing process 150 and/or the cake fractionation process 160 while awaiting transport.

A high value component storage system 180 incorporates specifically controlled storage conditions to ensure the integrity of high value components prior to transport.

Anaerobic digestion of the residual algal biomass in the anaerobic digester 190 following the cake fractionation process 160 allows for the recycling of many of the nutrients in the biomass, for example, in the form of methane and carbon dioxide.

Digested residual algal biomass solids and water from the anaerobic digester 190 are separated in a separator 200 to allow the return of the soluble nutrients to the algal bioreactor 120 without fouling the algal bioreactor 120 with inert solids. The separator 200 uses two stage separation, including filtration with a Z-filter, a standard belt press, a centrifuge or other similar device, followed my membrane filtration. It is to be understood that the separator 200 can use single stage separation, including filtration with a Z-filter, a standard belt press, a centrifuge, a membrane, or other similar device. It is also to be understood that the digested residual algal biomass solids and water from the anaerobic digester 190 can be fed back into the wastewater treatment system 10.

Solids separated from water in the separator 200 are stored in a solids storage system 210 while awaiting transport. These solids can be used as a soil conditioner, for example, for agricultural land, or further processed.

The gas stream produced in the anaerobic digester 190 contains methane, carbon dioxide, and other trace gases. These are captured in a gas capture system 220, and separated in a gas separation system 230. Carbon dioxide is recycled back to the algal bioreactor 120 during daylight hours for utilization by the algae. Methane is liquefied in a compressor 240 to facilitate storage for on-site use and/or for transportation off-site. It will be understood that the compressor 240 may be used to compress the methane without liquefying it.

While the anaerobic digester 190 produces gases 24 hours a day, algae in the algal bioreactor 120 can only utilize the carbon dioxide produced in the anaerobic digester 190 during daylight hours. Accordingly, during night time hours the carbon dioxide produced in the anaerobic digester 190 is compressed in a compressor 250 and stored under pressure in a carbon dioxide storage facility 260, for use in the algal bioreactor 120 during daylight hours. This maximizes the conversion of carbon dioxide to algal biomass.

The algal bioreactor 120 produces large amounts of oxygen as a by-product of the photosynthesis process during daylight hours. Excess oxygen can inhibit algal growth in the photosynthesis mode, therefore it is extracted at appropriate intervals and captured in a gas capture system 270, compressed in a compressor 280 and stored under pressure in an oxygen storage facility 290, for use in the algal bioreactor 120 during night time hours, when the algae is in its respiration cycle. This has the advantage of allowing for a smaller algal bioreactor 120 to be used, as all the algal biomass does not need to be produced during daylight hours.

It will be understood that the compressor 250 used to compress the carbon dioxide and the carbon dioxide storage facility 260 may be the same as the compressor 280 used to compress the oxygen and the oxygen storage facility 290, as carbon dioxide processing occurs at night and oxygen processing occurs during the day.

The method disclosed above has as an advantage the capture and reuse of gases, particularly carbon dioxide and oxygen, generated by a wastewater treatment system.

It should be appreciated that various other changes and modifications may be made to the embodiments described without departing from the spirit or scope of the invention.

1. A method of treating wastewater, the method including the steps of:
capturing carbon dioxide and oxygen produced during treatment of the wastewater by a wastewater treatment system; and
using the captured carbon dioxide and oxygen to promote the growth of algae contained within the wastewater treatment system.

2. The method of claim 1, wherein the wastewater treatment system comprises a population of bacteria.

3. The method of claim 2, wherein the bacteria are anaerobic bacteria.

4. The method of claim 3, wherein the carbon dioxide is from anaerobic digestion of constituents found in the wastewater.

5. The method of any one of claim 1-4, wherein the carbon dioxide is captured at night.

6. The method of claim 5, wherein the captured carbon dioxide is used during the day.

7. The method of claim 1, wherein the oxygen is from the algae contained within the wastewater treatment system.

8. The method of any one of claim 1-7, wherein the oxygen is captured during the day.

9. The method of claim 8, wherein the captured oxygen is used during the night.

10. The method of claim 1, wherein the wastewater treatment system comprises a membrane operating system.

11. The method of claim 1, wherein the wastewater treatment system comprises a membrane biological reactor.

12. The method of claim 1, further including the step of:
capturing methane produced during treatment of the wastewater by a wastewater treatment system.

13. The method of any one of claim 1-12, wherein the algae comprises a Spirulina spp.

14. The method of any one of claim 1-12, wherein the algae comprises lipid- or oil-producing algae selected from the group consisting of bacillariophytes, chlorophytes, cyanophytes, and chrysophytes.

15. A method of treating wastewater as herein before described with reference to the accompanying drawing.
